(19) United States
(12) Patent Application Publication
(10) Pub. No.: US 2025/0079549 A1
(43) Pub. Date: Mar. 6, 2025

(54) BATTERY BARRIER MATERIAL TESTING APPARATUSES AND METHODS OF USE THEREOF

(71) Applicant: UL LLC, Northbrook, IL (US)

(72) Inventors: Benjamin Gaudet, Chicago, IL (US); Alex Orzechowski, Hainesville, IL (US)

(21) Appl. No.: 18/820,243

(22) Filed: Aug. 29, 2024

Related U.S. Application Data
(60) Provisional application No. 63/535,304, filed on Aug. 29, 2023.

(51) Int. Cl. H01M 10/615; H01M 10/42; H01M 10/44; H01M 10/48; H01M 10/657; H01M 50/218; H01M 50/233; H01M 50/271; H01M 50/298; H01M 50/30

(52) U.S. Cl. CPC H01M 10/615; H01M 10/4285; H01M 10/44; H01M 10/486; H01M 10/657; H01M 50/218; H01M 50/233; H01M 50/271; H01M 50/298; H01M 50/30

(57) ABSTRACT

A method for testing a battery barrier material includes placing a barrier material around a plurality of battery cells and initiating thermal runaway of at least one of the plurality of battery cells. The method further includes measuring, during the thermal runaway, characteristics of at least one of the barrier material, the plurality of battery cells, or an environment around the barrier material or the plurality of battery cells.

### FIELD OF THE DISCLOSURE

The present disclosure relates generally to testing materials and more particularly to testing a materials used in groups of battery cells such as battery packs.

### SUMMARY

An illustrative method for testing a battery barrier material includes placing a barrier material around a plurality of battery cells and initiating thermal runaway of at least one of the plurality of battery cells. The method further includes measuring, during the thermal runaway, characteristics of at least one of the barrier material, the plurality of battery cells, or an environment around the barrier material or the plurality of battery cells.

An illustrative apparatus includes an enclosure, a plurality of battery cells surrounded by barrier material within the enclosure, and a heater configured to heat at least one of the plurality of battery cells. The heater is configured to initiate thermal runaway of at least one of the plurality of battery cells.

An illustrative apparatus includes a test surface, a hood above the test surface configured to provide ventilation to an area about the test surface, and a plurality of battery cells surrounded by barrier material. The plurality of battery cells rests upon the test surface. The apparatus further includes a heater configured to heat at least one of the plurality of battery cells. The heater is configured to initiate thermal runaway of at least one of the plurality of battery cells.

An illustrative apparatus includes a test sample, a heated boss, and an actuator configured to cause the test sample and the heated boss to be pressed together at a predetermined pressure level.

### BRIEF DESCRIPTION OF THE DRAWINGS

FIG. 1 is a diagrammatic view of an example battery barrier material, in embodiments.

FIG. 2 is a diagrammatic view of an example battery barrier material test enclosure, in embodiments.

FIG. 3 is a diagrammatic view of cap plate for a battery barrier material test enclosure, in embodiments.

FIG. 4 is a diagrammatic view of an example spacer for battery cells, in embodiments.

FIG. 5 is a diagrammatic view of an example battery barrier material test enclosure with battery cells, in embodiments.

FIG. 6 is a diagrammatic view of example battery cells arranged for a battery barrier material test, in embodiments.

FIG. 7 is a diagrammatic view of a cross-section of a battery barrier material test enclosure, in embodiments.

FIG. 8 is a diagrammatic top view of an example battery barrier material, in embodiments.

FIG. 9 is a diagrammatic side view of the example battery barrier material of FIG. 8, in embodiments.

FIG. 10 is a diagrammatic cross-sectional view of a of an example battery cell setup for thermal runaway testing, in embodiments.

FIG. 11 is a diagrammatic top view of the example battery cell setup an example battery cell setup for thermal runaway testing, in embodiments.

FIG. 12 is a diagrammatic view of an open air battery cell test setup with a ventilation hood, in embodiments.

FIG. 13 is a diagrammatic view of a battery barrier material test enclosure, in embodiments.

FIG. 14 is a diagrammatic view of a rectilinear barrier material test setup having a translatable arm to move a boss from a furnace to a battery barrier material test sample, in embodiments.

FIG. 15 is a diagrammatic view of a rectilinear barrier material test setup having an actuator configured to move a battery barrier material test sample onto a heated boss, in embodiments.

FIG. 16 is a diagrammatic view of a rectilinear barrier material test setup having an inductor coil, in embodiments.

FIG. 17 is a diagrammatic view of an example of a computing environment, in embodiments.

### DETAILED DESCRIPTION

The following description of example methods and apparatus is not intended to limit the scope of the description to the precise form or forms detailed herein. Instead the following description is intended to be illustrative so that others may follow its teachings.

Described herein are embodiments for apparatuses, systems, methods, and computer readable media for performing tests on materials, such as materials used for battery cells and battery packs, such as materials used to separate individual battery cells or batteries in a battery pack. Battery packs may be used in a variety of uses, including in electric vehicles (EVs) (including for locomotives, light electric vehicles, micro-mobility devices, bicycles, scooters, aircraft, marine craft, unmanned aerial or marine vehicles or drones, for example). Advantageously, the various embodiments described herein may expose a material that may be used in a battery enclosure to separate individual batteries packages and/or battery cells to various conditions that a barrier material may be exposed to when used in a battery pack, such as in a battery pack for an EV. For example, battery packs may experience a condition called thermal runaway, and it may be desirable for the barrier material to contain or help contain fire, temperature, pressure, or other aspects of a thermal runaway condition within a battery enclosure and between different batteries or battery cells within a battery pack. As such, the embodiments described herein provide for apparatuses, systems, methods, and computer readable media for performing such tests, including exposing potential battery barrier materials to actual or simulated conditions of a thermal runaway of a battery pack.

In various embodiments, a battery pack may be made up of lithium ion (Li-ion) or other types of battery cells of various form factors including prismatic, pouch, or cylindrical formals, and the embodiments may be designed to evaluate the materials used for containment, separation, and enclosure of such individual Li-ion battery cells, including in the event of a thermal runaway associated with one or more of the Li-ion battery cells. The Li-ion battery cells may include, for example, 18650 type Li-ion cells, 21700 type Li-ion cells, prismatic cells, pouch cells, or any other type of battery cells.

Various embodiments may include a test apparatus that may include an enclosure in which a test sample battery pack with individual batteries or cells having barrier material between them. The test apparatus may include a test sample holding mechanism, a pressure relief mechanism, openings for one or more measurement sensors and electrical wirings.

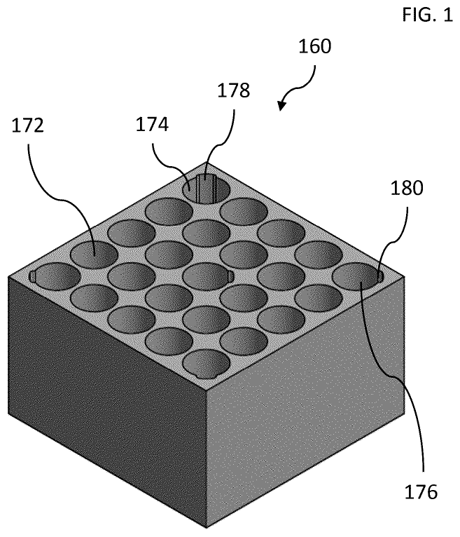

An example battery barrier material 160 is shown in FIG. 1, which may include example openings 172, 174, and 176 for individual batteries or battery cells to be inserted for a battery barrier material test. Various openings, such as the openings 174 and 176 may have notches 178 and 180, respectively, that allow for additional material beyond a battery or battery cell to be inserted into the openings. For example, the notches 178 and/or 180 may accommodate thermocouples or other temperatures sensors, air pressure sensors, heating elements to heat a given battery or battery cell up to a thermal runaway state, etc. The example battery material may include 1, 2, 4, 5, 6 or more notches 178, 180, as desired or needed.

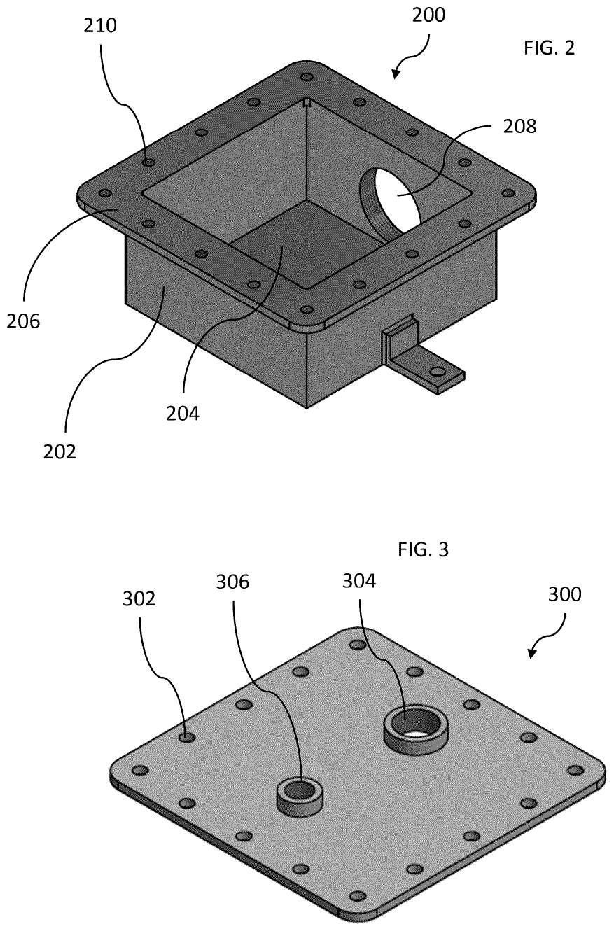

An example enclosure 200 into which the battery barrier material and batteries (or battery cells) may be placed in for testing is shown in FIG. 2. The enclosure 200 may include a main enclosure portion 202, which has an opening 204 in which the batteries, battery cells, and/or battery barrier materials may be placed. The enclosure 200 may also include an opening 208 that may serve as a vent to prevent the inside of the enclosure 200 from becoming too pressurized. The opening 208 may be threaded so that the opening 208 may be plugged or so that the opening 208 may be made smaller by inserting a nozzle or other similar component therein. The opening 208 may also act as a passthrough for wiring, instrumentation, etc., such as power wiring to power heaters used to drive batteries into thermal runaway; pressure, temperature, or other sensor wiring; instrumentation; wiring to one or more heating elements used to heat one or more battery cells up until they go into thermal runaway; etc.

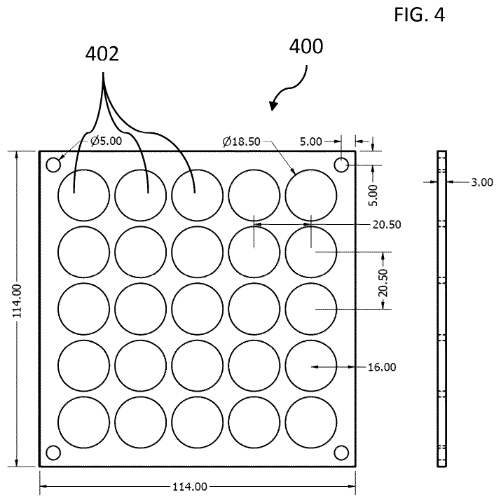

The enclosure 200 may also have a flange 206 with holes 210 that line of with holes 302 of FIG. 3 so that a cap plate 300 of FIG. 3 may be placed over the opening 204 of the enclosure 200 while a battery pack and/or barrier material is in the enclosure. The cap plate 300 may also have openings or passthroughs 304 and 306 to act as a passthrough for wiring, instrumentation, etc., such as power wiring to power the heaters used to drive batteries into thermal runaway; pressure, temperature, or other sensor wiring; wiring to one or more heating elements used to heat one or more battery cells up until they go into thermal runaway; etc. In various embodiments, one or more passthrough as described herein may be configured such that an internal chamber of the enclosure 200 is fluidly connected to a pressure sensor or transducer outside of the enclosure 200. In this way, air pressure within the enclosure 200 may be measured with the pressure sensor or transducer that is exposed to a same or similar fluid pressure to a pressure that exists within the enclosure 200.

A barrier plate 400 such as that shown below in FIG. 4 may be used to hold batteries or battery cells in place. This may be useful to keep battery cells aligned while a barrier material is filled in between individual batteries or cells, or may be used to hold battery cells in place during a test itself if the barrier material being tested is air between the battery cells. A test with the barrier plate 400 may be also be used to give comparative context to the performance of a test with a solid barrier material. The barrier plate may be made of low-carbon steel, stainless steel, cast ceramics, or other rigid, non-combustible materials. The barrier plate 400 may have openings 402 for each battery cell that are generally uniform in shape and cause each battery cell to be positioned a predetermined distance from adjacent battery cells. The predetermined distance between adjacent battery cells may also be equal or substantially equal between each cell of the plurality of battery cells, as demonstrated in the barrier plate 400 of FIG. 4.

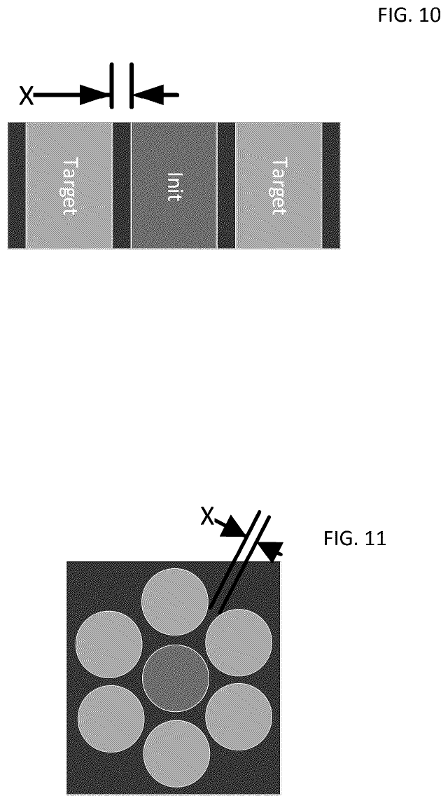

Although a rectangular 5×5 array arrangement of battery cells is shown in FIGS. 4-6 and 8, other sizes and configurations of battery cells may be used in various embodiments. For example, larger or smaller arrays may be used. For example, arrays of anywhere from 2 to 25 battery cells may be tested, or even greater numbers of cells. Differently shaped arrangements may be used, such as the shape shown in FIGS. 10 and 11. Other shapes than squares or rectangles may also be used, such as diamonds, honeycombs, circular shapes, or any other shape desired with any number of batteries or battery cells desired. In addition, while the example illustrated in the figures show a uniform distance between adjacent battery cells and battery barrier materials between battery cells, non-uniform distances may also be used so that different battery cells may have different distances between them for a given test and/or differing amounts and differing types of barrier material between the cells. The shape of the cells may also vary, such as cells having a cylindrical, pouch, prismatic, button, or other shape.

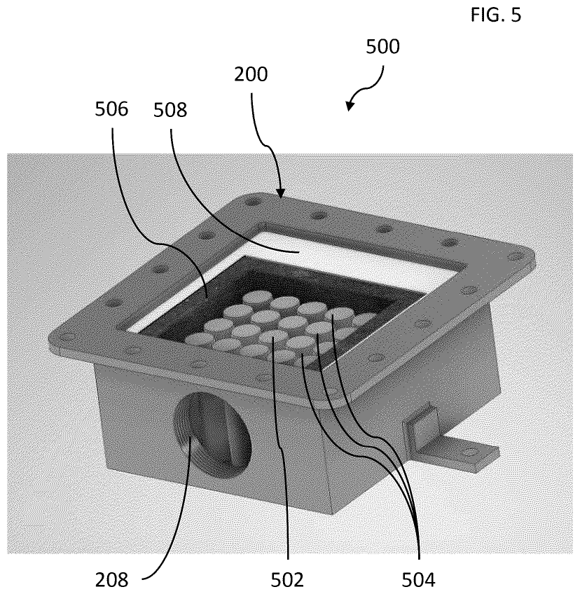

In FIG. 5, the test enclosure 200 with a flanged top is compatible with the cap plate 300 and with the mating top cover such as the components above is shown. A high temperature silicone gasket may also be used to seal the interface between the flange of the enclosure with the mating top cover. Threaded flange holes may be used to bolt the cover in place. A top cover with a threaded inlet for pressure and temperature measurements may be used, and a threaded orifice (e.g., the opening 208) inserts for pressure and ventilation modulation.

The enclosure may have an internal volume sufficient to fit a range of sizes of configurations or arrays of batteries or battery cells, such as various arrays of 18650 cells or other types of cells, as well as configurations with barrier materials between the battery cells. Example battery cells 502 and 504 are shown in FIG. 5. The battery cell 502 may be heated to thermal runaway conditions as described herein. The systems and apparatuses may also include insertable wall sections 506 and 508 to adjust the amount of free volume within enclosure. Such inert materials may be used to displace free volume behind wall sections such that the same free volume can be achieved for a range of test configurations of batteries, battery packs, battery cells, and/or battery barrier sample thicknesses/orientations/types/etc. The battery cell 502 may be the cell where thermal runaway is initiated (e.g., the cell that is heated by a heating element or heater).

FIG. 5 shows an example test setup with a 5×5 array of battery cells with 2 millimeter (mm) air gaps and insertable inert materials (e.g., wall sections 506 and 508) to reduce the free volume to the area immediately surrounding the cell array. The wall section 506 may be made up of an inert wall material such as ceramic fiber blanket, calcium-silicate board, mineral fiber insulation, or other noncombustible insulation materials and the wall section 508 may be an inert insulation material such as ceramic fiber blanket, calcium-silicate board, mineral fiber insulation, or other noncombustible insulation materials.

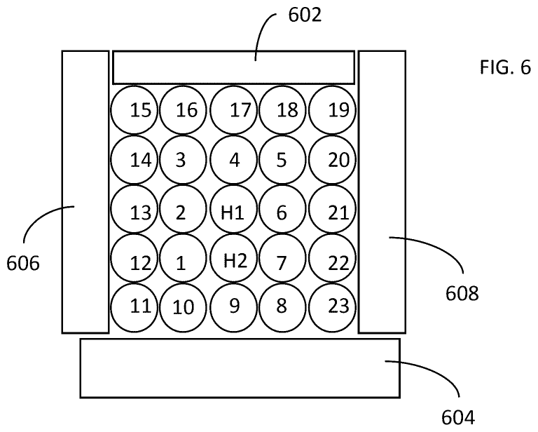

In FIG. 6, a group of battery cells is shown, which may for example be the batteries in the test enclosure of FIG. 5. As shown in FIG. 6, a sensor or thermocouple associated with each battery cell may numbered to keep track of a characteristic such as temperature of each sensor or thermocouple as a battery barrier test is performed. While each cell in FIG. 6 is numbered and therefore associated with a sensor or thermocouple, various embodiments may not have a sensor or thermocouple associated with each and every battery or battery cell (e.g., some of the cells on the outside perimeter of the array may not have a thermocouple associated therewith). The H1 and H2 cells may be the cells that are heated to initiate thermal runaway, and measurements may be taken at some or all of the other cells to track how quickly and in what pattern the thermal runaway spreads between cells. Also shown in FIG. 6 are additional inserts 602, 604, 606, and 608 that may be placed around the array of battery cells within an enclosure. The space between each of the battery cells in the array may be filled with air or another battery barrier material as desired or specified for a given test.

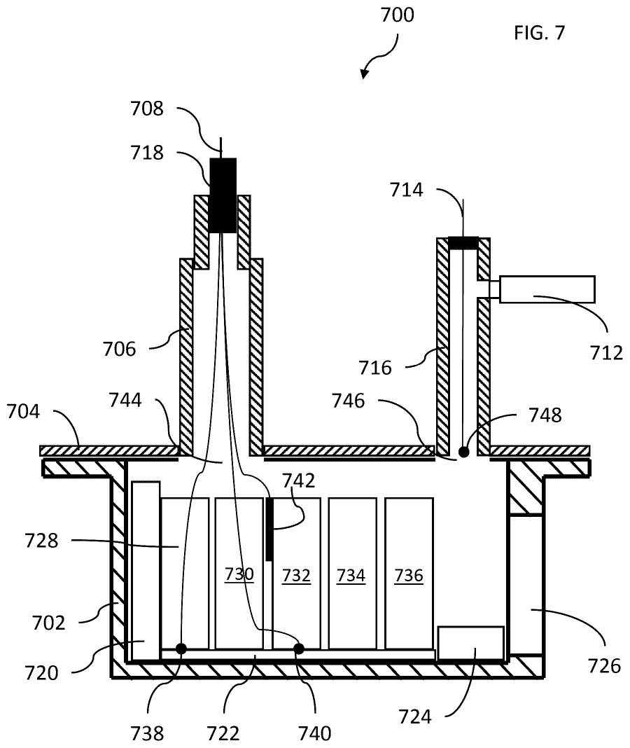

FIG. 7 shows an example test setup 700 that shows a cross-sectional view of an enclosure 702 with battery cells 728, 730, 732, 734, and 736 therein, as well as possible locations 738, 740, and 748 of sensor or thermocouple junctions for measuring temperature within the enclosure. While three possible locations for sensor or thermocouple junctions are shown in FIG. 7, various embodiments may have more or less sensors or thermocouple junctions as described herein (e.g., there may be temperature sensors or thermocouples associated with each and every battery cell in the test in some embodiments). For example, thermocouple junctions 738 and 740 may be placed at the bottom of battery cells as shown in FIG. 7, but may be placed at other locations in various embodiments. Another thermocouple junction 748 may be placed at an opening 746 of a cap plate 704 of the enclosure 702. At each of the thermocouple junctions in a given test (e.g., at 738, 740, and 748 in the example of FIG. 7), superglue or other adhesive may be used to fasten the thermocouple wiring to the location to further secure the wiring to a desired location. In this way, the thermocouple junctions may be more secure given the amount of pressure, heat, kinetic force, or other forces the thermocouple junctions may be subjected to during a test as described herein. That opening 746 may also fluidly connect an inside of the enclosure with a diaphragm pressure transducer 1008 as described herein. Another opening may have piping and an epoxy-sealed pass through 1002 so that wiring can pass into the enclosure (e.g., for power, heaters, sensors, thermocouples, etc.) without creating any openings or any significant openings in the enclosure. In various embodiments, the various example openings 744, 748, and/or 726 shown in FIG. 7 may be located in different locations, such as on the cap plate 704 of the enclosure 702 or in the walls of the enclosure 702.

The cap plate used in various embodiments (e.g., the cap plate 300 shown in FIG. 3, the cap plate 704 shown in FIG. 7) may be, for example, a ¼″ steel cover attached to an enclosure via a flange. As shown in FIG. 7, the enclosure 702 may have the cap plate 704, and a pipe 706 may be installed onto the top of the cap plate 704 at the opening 744 to allow instrumentation, sensors and/or other measurements inside the enclosure/cell containment area, such as pressure measurement and temperature measurements inside the enclosure/cell containment area. Wiring 708 may pass through an epoxy seal 718 an connect to the thermocouple junctions at 738 and 740 and a heating element 742, for example. The epoxy seal 718 may be added before a test begins, and may be permitted to cure before the test begins. A pipe tee 716 may further fluidly connect the inside of the enclosure 702 with a pressure sensor/transducer 712. A wire 714 may connect to a thermocouple or other temperature sensor at location 748 for measuring air temperature within the pipe tee 716 or elsewhere depending on where the thermocouple or temperature sensor is placed. The wiring 708 that passes through piping 706 into the enclosure 702 may include wiring for any combination of powering the battery cells 728, 730, 732, 734, and 736, powering heating elements (e.g., heating element 742) within the enclosure 702, connecting to thermocouples or other temperature sensors within the enclosure 702 (e.g., at locations 738, 740, and 748), connecting to any other type of sensor within the enclosure 702 for providing power or instrumentation/control signals, etc. The wiring 708 may include wiring to power the heating element 742 and for connecting to thermocouples or sensors at the locations 738 and 740 for example, and further wiring may be used for additional sensors or devices within the enclosure in various embodiments other than those shown in FIG. 7. Other wiring may further be used for additional sensors or devices that may not be attached to or associated with individual battery cells. FIG. 7 further shows opening 726 that may be used for venting the enclosure 702. Also in the enclosure 702 may be wall materials 720, 722, and 724 as described herein.

A test method may include use of a flexible film heater (e.g., the heating element 742 of FIG. 7) to force one or more cells into thermal runaway to initiate a test. To measure thermal runaway propagation, thermocouples may be installed on the bottom surface of each cell (e.g., at locations 738 and 740 of FIG. 7), the side surface of each cell, the top surface of each cell, and/or any other location on or near a cell. In an embodiment, for example, the 18650 battery cells with the plastic jacketing may be approximately 18.2-18.4 mm in diameter. The plastic jacketing may be part of an as-manufactured battery cell and separate from a battery barrier material tested according to the various embodiments described herein. An 18650 cell without the jacket, but with a film heater installed is approximately 18.5 mm in diameter. The film heater may be used to drive the cell into thermal runaway. As such, to aid in driving a cell into thermal runaway, the initial cell desired to go into thermal runaway may have its plastic jacketing removed for a given battery barrier material test.

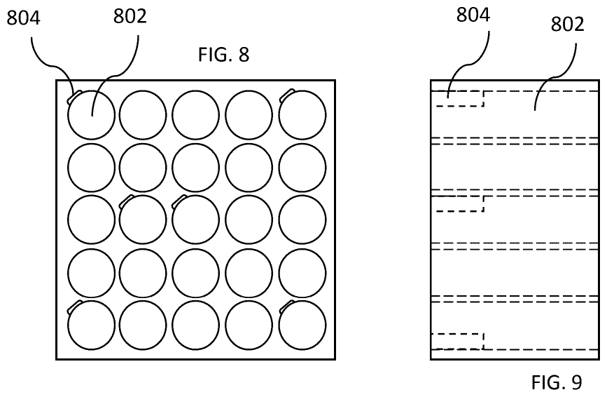

The sample material may therefore include cylindrical slots with a diameter of 18.5 mm to accommodate both test cells (with a jacket) and initiating cells (with a film heater). FIG. 8 shows an example sample barrier material similar to that shown in FIG. 1. In the example of FIG. 8, a slot 802 for a battery cell may include a small, slotted channel 804 that may also be used in the barrier material next to an initiating cell to accommodate the heater leads, such as the heater lead 742 in FIG. 7. FIG. 1 also includes these notches or channels to accommodate a heater lead. Various embodiments may use a 2 millimeter (mm) spacing of separation between adjacent cells for a given test. However, various embodiments may use other spacings and even varied spacings between cells. For example, a separation distance between cells may be less than 1 millimeter (mm), less than 2 mm, greater than 2 mm, greater than 3 mm, greater than 4 mm, or may be any other spacing such as several millimeters (mm) in thickness. In the example of FIG. 8, six of the cylindrical slots could include channels, slots or notches for heater leads at different potential initiating locations, while the example barrier material of FIG. 1 includes five such slots. Manual alterations or additions to the barrier material may also be made as desired for a given test. FIG. 9 shows a side view with the slot 802 and the notch 804 in dotted lines. As shown, the notch 804 may not extend the entire length of the slot 802.

In each test, various measurements may be captured such as temperature at each cell or battery using a thermocouple measurements versus time (e.g., at a rate of 1 hertz (Hz)), the cell heater temperature versus time (e.g., the heater(s) that forces a cell into thermal runaway), a pattern of thermal runaway propagation between battery cells, enclosure pressure versus time (e.g., at a rate of 10 Hz or greater), video data, etc.

In various embodiments, battery cells arranged for a test with air gaps between cells or battery barrier material spacing may be held in place by a wire frame or basket. In another example, battery cells having air gaps between them may be held in place by a plate similar to that shown in FIG. 4. In various embodiments, two plates as shown in FIG. 4 may be used to secure a top and bottom of each cell and the two plates may be fastened together. In other embodiments one plate or greater than two plates may be used. As described herein, the test may be conducted with air gaps between the battery cells to get a baseline for how quickly thermal runaway may spread among an array of battery cells of a given type, geometric configuration and spacing with no battery barrier material.

Such setups (e.g., using a wire frame or basket, using a plate as shown in FIG. 4) may also be used to hold battery cells in place while a battery barrier material is packed or otherwise put in place as desired around the battery cells in advance of testing. Then the wiring or plates of may be removed or remain during testing, as desired or specified.

As such, the embodiments described and shown in the figures demonstrate example embodiments of test fixtures and methods for testing a barrier material for batteries or battery cells within a test enclosure. The embodiments may also be used to test different shapes of battery materials around the battery cells. Different tests may also be used that include different types of barrier materials such as potting materials, encapsulation materials, solid insulation materials, fibrous insulation materials, gel materials, loose-fill materials, intumescing materials, and/or foam materials, and the systems and methods herein may be used to perform baseline tests where no barrier material is used between cells. In such tests, the batteries or battery cells may have zero clearance (no gap) between them, or may have an air gap clearance as described herein (e.g., 2 millimeters (mm) between cells), or may have a gap as wide as desired for accommodating the desired materials (including differing gaps between various cells), and may include a combination of barrier materials, no gap, and/or air.

Various embodiments described herein relate to testing a barrier material in an enclosure using an array of batteries or battery cells. In various embodiments, the battery cells and barrier material may also be tested in open-air (e.g., in a large testing room) or within a relatively large enclosure in comparison to the combined size of the test article consisting of battery cells and the barrier material configuration). Such tests may be referred to as meso-scale tests.

A meso-scale test method may be used, for example, for lithium-ion battery barrier materials. The function of the test methods and apparatuses may be to provide testing capacity for customizable and varying battery cell types and barrier material configurations of varying sizes and dimensions. The test methods and apparatuses may provide heat transfer and thermal runaway propagation data for the specified cells and barrier material configuration to comparatively screen candidate barrier materials.

An battery pack for a battery powered product may have total energy capacities up to 100 kilowatt-hours (kWh), and various battery packs may be smaller or larger than 100 kWh. These packs may include multiple cells. The battery cells may also come in various form factors, such as cylindrical, prismatic, pouch, and/or other form factors. The energy capacity and dimensions of the cells may depend on the design of the battery pack. For example, cylindrical cells may be as small as an 18650 battery cell format (e.g., 18 mm diameter by 65 mm tall) or as large as newer 4680 format battery cells (e.g., 46 mm in diameter by 80 mm tall). Pouch and prismatic cells may have even larger average dimensions than cylindrical cells in energy storage and EV applications. For example, the length scale of some cells, such as pouch cells, may be up to 600 mm (24 inches) or more.

In various embodiments, when testing a barrier material as described herein, a manufacturer of that material may specify a type of battery cell and/or size of battery pack to assemble to perform a test on the barrier material. In various other embodiments, a manufacturer may provide a particular battery cell and/or battery pack configuration of interest for using to test a barrier material.

The table below further shows operations which may be performed, in whole or in part, to perform a meso-scale test according to the various embodiments described herein.

TABLE 2

| Task # | Description |
|---|---|
| 1 | Determination of thermal runaway propensity of a single test |
| | cell. |
| 2 | Characterization of thermal runaway propagation among a small |
| | array of the test cells with an air gap between cells |
| 3 | Characterization of thermal runaway propagation among a small |
| | array of the test cells with the same thickness of test material |
| | between the cells |

The cell test package may be designed as follows. A single cell may be driven into thermal runaway and may be sufficient to cause thermal runaway propagation to adjacent cells in an array. A minimum of a single layer of cells adjacent to the initiating cell may be used in various tests. In various embodiments, additional initiating cells or additional layers of surrounding cells may be added.

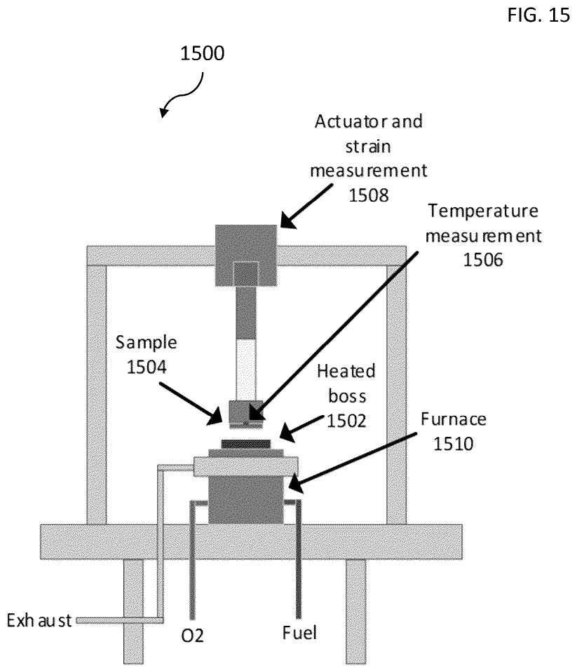

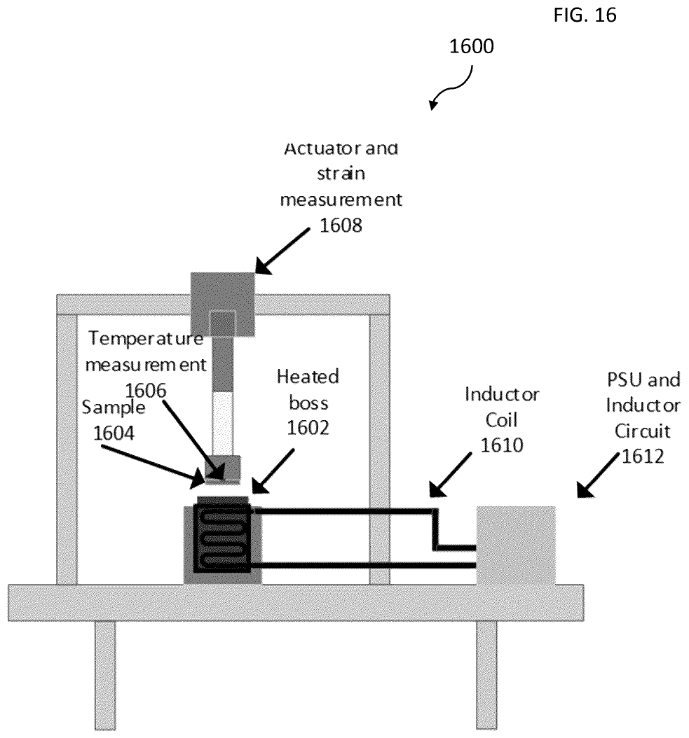

In various embodiments, and depending on the cells tested, test package dimensions may range from approximately 75 mm×75 mm×65 mm (3 in×3 in×2.5 in) to approximately 600 mm×305 mm×305 mm (24 in×12 in×12 in) or larger. FIGS. 15 and 16 show an example test package that may be used in a meso-scale test, where battery cells are separated by a barrier material of a thickness of dimension x. FIG. 10 shows a basic pouch and prismatic cell test package from a side or cross-sectional view. FIG. 11 shows a basic cylindrical cell test package from a top view.

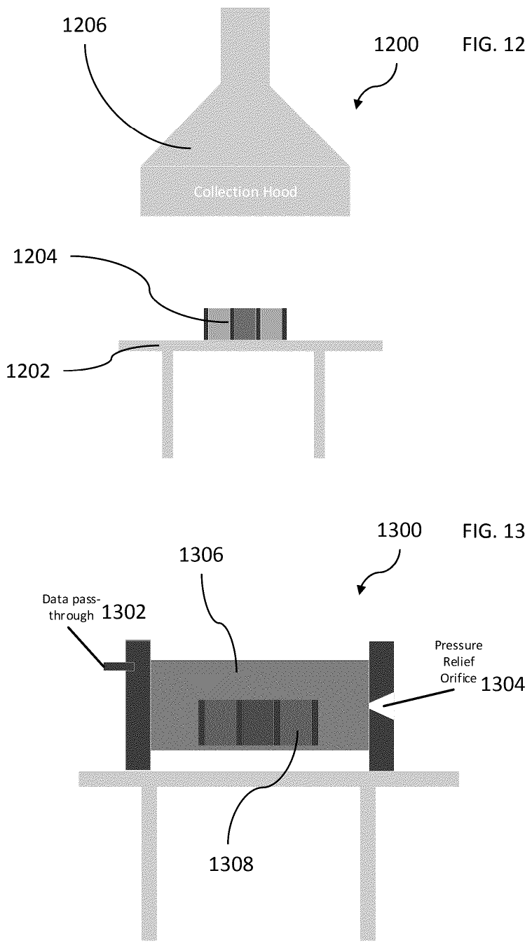

An example meso-scale test setup 1200 is shown in FIG. 12. This may be referred to as an open-air thermal runaway propagation test. The test setup may provide for a wide range of battery pack test packages of different sizes and shapes to be tested. The test setup may also be configured such that flaming combustion may be present in the test condition due to the open-air configuration. Additional temperature sensors/thermocouples or other configurations may also be used in the environment around the battery pack to determine a capacity for combustion heat release rate measurement. The test setup 1200 in FIG. 12 may also provide for elimination or reduction of hazards due to high pressure and/or directional high-velocity combusting gas flows that may occur in a pressurized test vessel/enclosure. FIG. 12 includes a collection or ventilation hood 1206, a battery pack 1204, and a test surface 1202.

Another example meso-scale test setup 1300 is shown in FIG. 13. This may be referred to as a closed vessel test setup. With a closed vessel 1306, combustion conditions may be representative of an interior of a battery pack 1308 while it is in use (e.g., at least during the beginning of a thermal runaway event). For example, closed vessel 1306 may also provide insulation of the battery cells from ambient air cooling and may provide increased retention of dissipated heat and gases during thermal runaway. The closed vessel 1306 may further provide a single cylindrical vessel size large enough to accommodate a range of test packages. An example vessel may have approximate internal dimensions of 760 mm long×460 mm diameter (30 inches long×18 inches diameter). The example vessel may further have flanged ends for internal pressure rating of approximately 600 psig or more per ASTM pressure vessel code design requirements. A pressure relief orifice 1304 may also be provided for continual release of pressure and thermal runaway gases. The example vessel may further include a secondary pressure relief burst disk and instrumentation cable pass-throughs 1302. The example vessel 1806 may further include pre-sized inserts of inert and insulative material to reduce internal volume if needed for smaller test packages.

Such inserted inert material may reduce internal volume of the vessel 1306 chamber. The vessel 1306 may further be sized up even larger to a drum or box shape, and may optionally include a cover or top plate as described herein, despite being larger in size with respect to any battery pack and barrier material being tested therein (e.g., there may be open space or air within any closed vessel used).

Further embodiments may relate to a testing of battery barrier material without the use of battery cells being driven into thermal runaway. For example, rectilinear or other shaped samples of barrier material may be used to provide performance screening for materials to be used in lithium-ion battery pack applications. Such barrier materials may be used in between pouch or prismatic battery cells, for example. In such example cases, the geometric profile of the barrier materials placed between the cells may be rectilinear (rectangular in shape). This may be in contrast with cylindrical cell barrier materials which may be potted or filled around batteries or battery cells and create a curved geometric profile around the cylindrical cells. The output of such a test may enhance the ability to test, design, and select materials for mitigation of thermal runaway propagation between pouch and prismatic cells. In various embodiments, different types of battery barrier materials may be used. For example, potting materials and encapsulation materials such as epoxies or resins may be used to fill in between battery cells via injection and hardening/curing, via manual packing, etc. Other barrier materials may be pre-formed into a desired shape to hold cells, such as shown in FIGS. 1 and 8, which may be made of materials such as ceramics, plastic and fibrous composite materials, resins, and epoxies.

Such tests may include subjecting a material sample (e.g., 2-3 inches square, may be of varying thicknesses) to a sudden extremely high temperature on one side (the hot side) while simultaneously compressing the sample between the exposing hot surface and another surface (on the cold side). The cold side is instrumented with one or more thermocouples. The source of thermal exposure on the hot side may be a super-heated metal or ceramic boss heated to a typical range of 600 C-1200 C, with higher excursions possible. The pressure may be generated by a hydraulic or pneumatic actuator which can deliver pressures in the range of 2-100 psig or higher. This test configuration may represent thermal runaway of a cell on the hot side of the sample with associated thermal and pressure stresses. The super-heated boss may be allowed to cool slowly upon contacting the sample, which may represent a real-world thermal profile of thermal runaway exposure. The super-heated boss may also be maintained at a target temperature indefinitely. The performance of the sample (compression strain, heat transfer in terms of cold-side temperature rise, melting, charring, etc) may be recorded, such that an output of the test would may be performance data such as heat transfer time and/or compressive strain in relation to exposure temperature and pressure, which may be used to categorize performance for ratings or otherwise determining the ability of a given material to serve as battery barrier material.

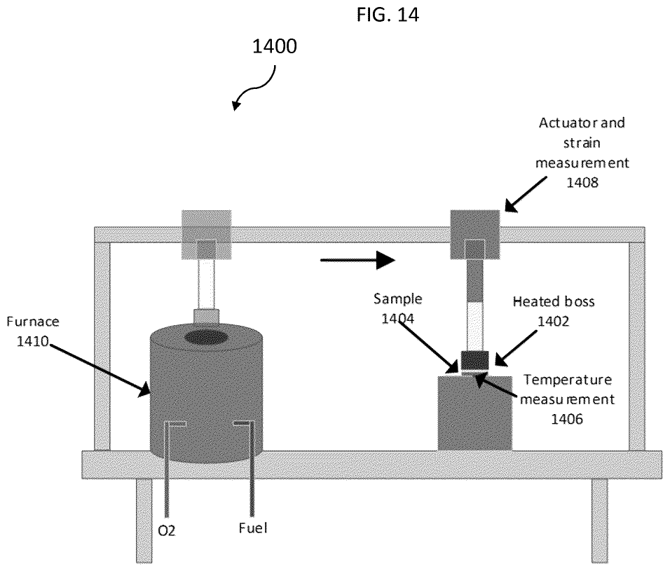

FIGS. 14-16 show example embodiments. Each of FIGS. 14-16 have a pressure generating actuator along with an energy source to heat a heat source such as a boss as well as a mechanical means of applying the heat source to the sample with a desired pressure. The embodiments may further include sensors for measuring temperatures and compressive strain (e.g., dimensional change in the direction of applied stress).

FIG. 14 is a diagrammatic view of a rectilinear barrier material test setup 1400 having a translatable arm to move a boss 1402 from a furnace 1410 to a battery barrier material test sample 1404. A thermocouple or other temperature sensor 1406 may be placed on a bottom or cold side of the sample. An actuator and strain measurement sensor 1408 may be located on the translatable arm so that the boss 1402 may be applied or caused to contact the sample 1404, and the strain measurement sensor may output how much pressure is being applied to the sample 1404 with the boss 1402. The actuator may be controllable by a computing device such that a desired or predetermined amount of pressure may be applied.

FIG. 15 is diagrammatic view of a rectilinear barrier material test setup 1500 having an actuator configured to move a battery barrier material test sample 1504 onto a heated boss 1502. The furnace 1510 in this embodiment may be adjacent to the boss 1502 so that the boss may not need to be moved. Instead, the sample 1504 is moved by the actuator of the actuator and strain measurement sensor 1508. A temperature sensor 1506 may be located on the top or cold side of the sample 1504.

FIG. 16 is a diagrammatic view of a rectilinear barrier material test setup 1600 having an inductor coil 1610 The inductor coil 1610 may cause the boss 1602 to be heated to a desired or predetermined temperature. The boss may be held in place by a supporting structure. Then the actuator and strain measurement 1608 may be moved to cause the sample 1604 to contact the boss 1602 similar to FIG. 16. A temperature sensor 1606 may be used to measure the cold side of the sample 1604 and a strain sensor may be used to measure and track the strain or pressure applied to the sample 1604. The inductor coil 1610 may further be connecting to a controller or computing device including an inductor circuit 1612 so that the inductor coil 1610 may be supplied with power and controlled to reach a desired or predetermined temperature.

Although certain example methods, apparatuses, and computer readable media have been described herein, the scope of coverage of this patent is not limited thereto. On the contrary, this patent covers all methods, apparatus, computer readable media, and articles of manufacture fairly falling within the scope of the appended claims either literally or under the doctrine of equivalents.

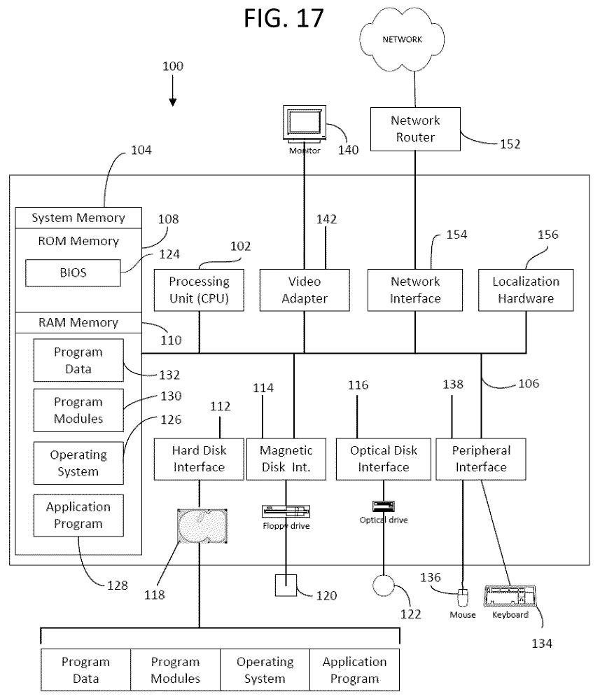

FIG. 17 is a diagrammatic view of an example embodiment of a user computing environment that includes a general-purpose computing system environment 100, such as a desktop computer, laptop, smartphone, tablet, or any other such device having the ability to execute instructions, such as those stored within a non-transient, computer-readable medium. The aspects of the figure below may be used in accordance with the embodiments herein to control or receive data from sensors, control or receive data from a heater used to push battery cells into thermal runaway, control an actuator to move a component, determine whether a desired/predetermined pressure or temperature level has been reached and react accordingly, etc. In addition, the aspects of the figure below may have instructions stored thereon for implementing any of the methods or functions described herein. As such, non-transitory computer-readable instructions may be stored on a computer readable medium (or on computer-readable media) and executable by a processor for testing a battery barrier material as described herein.

Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In embodiments, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method comprising:
placing a barrier material around a plurality of battery cells;
initiating thermal runaway of at least one of the plurality of battery cells; and
measuring, during the thermal runaway, characteristics of at least one of the barrier material, the plurality of battery cells, or an environment around the barrier material or the plurality of battery cells.

2. The method of claim 1, wherein the initiating the thermal runaway of the at least one of the plurality of battery cells comprises raising a temperature of one of the at least one of the plurality of battery cells above a threshold temperature.

3. The method of claim 1, wherein the initiating the thermal runaway of the at least one of the plurality of battery cells comprises raising a temperature of at least two of the at least one of the plurality of battery cells above a threshold temperature.

4. The method of claim 1, wherein the barrier material is placed between each of the plurality of battery cells.

5. The method of claim 1, wherein the plurality of battery cells are arranged in an array.

6. The method of claim 1, further comprising, prior to the initiating of the thermal runaway of the at least one of the plurality of battery cells, charging each of the plurality of the battery cells to a threshold charge level.

7. The method of claim 1, wherein the measuring of the characteristics comprises measuring a temperature, during and after the thermal runaway of the at least one of the plurality of battery cells, of at least one of the barrier material, the plurality of battery cells, or the environment around the barrier material or the plurality of battery cells.

8. The method of claim 1, further comprising placing, prior to the initiating of the thermal runaway, the plurality of battery cells and the barrier material into a test enclosure.

9. The method of claim 8, further comprising placing, prior to the initiating of the thermal runaway, a cap plate over an opening of the test enclosure.

10. An apparatus comprising:
an enclosure;
a plurality of battery cells surrounded by barrier material within the enclosure; and
a heater configured to heat at least one of the plurality of battery cells, wherein the heater is configured to initiate thermal runaway of the at least one of the plurality of battery cells.

11. The apparatus of claim 10, wherein the enclosure comprises at least two openings, wherein a first opening is configured to passthrough wiring of the heater and a second opening is configured to vent a chamber of the box while a sample is attached.

12. The apparatus of claim 10, further comprising at least one thermocouple for measuring temperature within the enclosure.

13. The apparatus of claim 12, wherein the enclosure further comprises a passthrough fluidly connecting an inside of the enclosure and an air pressure sensor.

14. The apparatus of claim 10, wherein a thickness of the barrier material between adjacent cells of the plurality of battery cells is substantially the same.

15. The apparatus of claim 10, wherein a distance between adjacent cells of the plurality of battery cells is substantially the same.

16. The apparatus of claim 10, wherein the enclosure comprises a test enclosure portion and a cap plate portion, wherein the cap plate portion is removably attachable to the test enclosure portion.

17. An apparatus comprising:
a test surface;
a hood above the test surface configured to provide ventilation to an area about the test surface;
a plurality of battery cells surrounded by barrier material, wherein the plurality of battery cells rests upon the test surface; and
a heater configured to heat at least one of the plurality of battery cells, wherein the heater is configured to initiate thermal runaway of the at least one of the plurality of battery cells.

18. An apparatus comprising:
a test sample;
a heated boss;
an actuator configured to cause the test sample and the heated boss to be pressed together at a predetermined pressure level.

19. The apparatus of claim 18, wherein the test sample comprises a first side that contacts the heated boss and a second side opposite the first side, and wherein the apparatus further comprises a temperature sensor or thermocouple located on the second side of the test sample.

20. The apparatus of claim 18, further comprising at least one sensor configured to measurement of at least one of strain or deformation of the test sample while the test sample and the heated boss are pressed together.

21. The apparatus of claim 18, further comprising a furnace or induction coil configured to heat the heated boss to a predetermined temperature.
